(19) United States
(12) Patent Application Publication
(10) Pub. No.: US 2015/0066810 A1
(43) Pub. Date: Mar. 5, 2015

(54) SYSTEMS AND METHODS FOR OBTAINING A DETERMINISTIC VALUE FOR ONE OR MORE FINANCIAL PRODUCTS

(71) Applicants: Abhra Roy, Bangalore (IN); Raktim Singh, Bangalore (IN); Vinay Prasad, Bangalore (IN)

(72) Inventors: Abhra Roy, Bangalore (IN); Raktim Singh, Bangalore (IN); Vinay Prasad, Bangalore (IN)

(73) Assignee: INFOSYS LIMITED, Bangalore (IN)

(21) Appl. No.: 14/385,457

(22) PCT Filed: Mar. 23, 2012
(86) PCT No.: PCT/IN2012/000193

§ 371 Date: Sep. 15, 2014

(51) Int. Cl. G06Q 40/06

(52) U.S. Cl. CPC G06Q 40/06
USPC 705/36 R

(57) ABSTRACT

The invention relates to a system and method for obtaining a deterministic value for one or more financial products. This invention defines one or more rules to obtain the deterministic value for the one or more financial products. The one or more rules include an interest rule, a principal rule and a currency rule. The one or more rules are attached to the one or more financial products and executed at the time of cash flow event calculation to obtain the deterministic value of the interest, the mode of payment and the currency of payment for the one or more financial products.

### FIELD OF THE INVENTION

The present invention relates to obtain a deterministic value for one or more financial products, and in particular, to systems and methods for obtaining a deterministic value of an interest, a mode of payment and a currency of payment for one or more financial products.

### BACKGROUND

Financial products like structured products are complex products which have a deposit component and an option component. Products have a guaranteed interest component and an enhanced interest component. Product owners in the bank would have to create such products and would need product rules to calculate these variable interest components for the product and also the mode of payment and currency of payment. Financial Product may require complex rules to determine value of interest, mode of payment or currency of payment based on various underlying. It is difficult to calculate the variables manually and the product owners find it difficult to simulate or reconcile the value determined for those products by the issuer or by bank treasury. The product owners in the bank need to the IT team in banks to handle these rules.

In view of the foregoing discussion, there is a need for a rule engine having a simple user front end that would help financial product owners to create the rules and map the rules to various financial products.

### SUMMARY

The present invention has provided a business rule front end by which the financial product owners can create the business rules and map the rules to the financial products. This can be used in retail banking to deposit products with some underlying. According to the present embodiment, a method for obtaining a deterministic value of an interest, a mode of payment and a currency of payment for one or more financial products is disclosed. The method includes defining one or more rules for obtaining the deterministic value of the interest, the mode of payment and currency of payment for the one or more financial products. Thereafter the one or more rules are attached to the one or more financial products. After that, the one or more rules are executed at the time of cash flow event calculation to obtain the deterministic value of the interest, the mode of payment and the currency of payment for the one or more financial products.

In an additional embodiment, a system for obtaining a deterministic value of an interest, a mode of payment and a currency of payment for one or more financial products is disclosed. As disclosed, the embodiment includes a rule definition module, a rule attachment module and a rule execution module. The rule definition module is configured to define one or more rules for the one or more financial products. In accordance with an embodiment of the present invention, the rule definition module includes an interest rule definition module configured to define one or more interest rules to obtain the deterministic value of the interest, a currency rule definition module configured to define one or more currency rules to obtain the deterministic value of the currency of payment and a principal rule definition module configured to define one or more principal rules to obtain the deterministic value of the mode of payment. The rule attachment module is configured to attach the one or more rules to the one or more financial product. The rule execution module is configured to execute the one or more rules to obtain the deterministic value of the interest, the mode of payment and the currency of payment for the financial product. In accordance with an embodiment of the present invention, the one or more rules are executed at the time of cash flow event calculation.

In another embodiment, a computer program product for obtaining a deterministic value of an interest, a mode of payment and a currency of payment for one or more financial products is disclosed. The computer program product includes a computer usable medium having a computer readable program code embodied therein for obtaining a deterministic value of an interest, a mode of payment and a currency of payment for one or more financial products. The computer readable program code storing a set of instructions configured for defining one or more rules for the one or more financial products, attaching the one or more rules to the one or more financial product, executing the one or more rules to obtain the deterministic value of the interest, the mode of payment and the currency of payment for the financial product.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a block diagram illustrating a system for obtaining a deterministic value of an interest, a mode of payment and a currency of payment for one or more financial products, in accordance with an embodiment of the present invention.

FIG. 3 is a flowchart, illustrating a method for obtaining a deterministic value of an interest, a mode of payment and a currency of payment for one or more financial products, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present disclosure provide a system and method for obtaining a deterministic value of an interest, a mode of payment and a currency of payment for one or more financial products where one or more rules are defined for the one or more financial products and then the one or more rules are attached to the one or more financial products. The one or more rules are executed at the time of cash flow event calculation to obtain the deterministic value of the interest, the mode of payment and the currency of payment for the financial product.

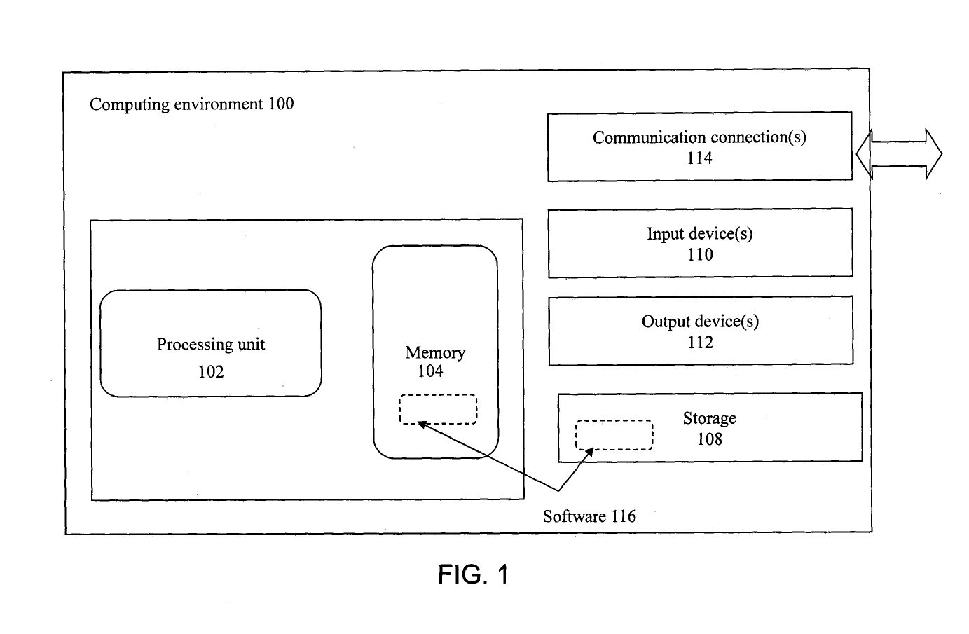

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can, for example, implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

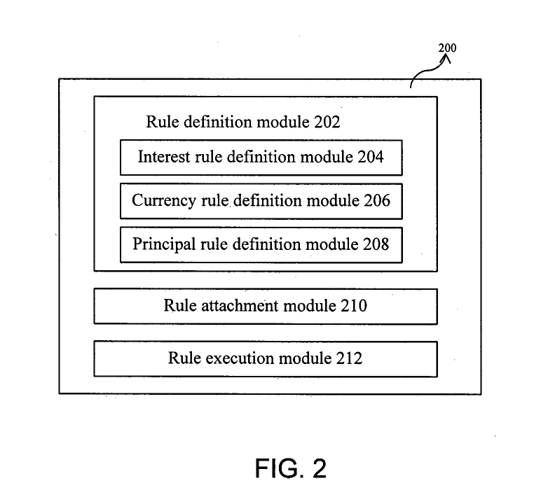

FIG. 2 is a block diagram illustrating a system for obtaining a deterministic value of an interest, a mode of payment and a currency of payment for one or more financial products, in accordance with an embodiment of the present invention. More particularly, in FIG. 2, a system 200 includes a rule definition module 202, a rule attachment module 210 and a rule execution module 212. In various embodiments of the present disclosure, the rule definition module 202 is configured to define one or more rules for the one or more financial products. The one or more rules are associated with a function code and a Rule ID. The examples of the function code includes but are not limited to Add, Copy, Delete, Inquire, Modify, Verify and Cancel. The Rule ID is used to identify the one or more rules. The Rule ID is required to be specified in “Add” function code and for other function codes the Rule ID may be selected from a list. For a Rule ID, either one or more rules can be defined or one or more scripts can be attached. The one or more scripts provide flexibility to users to have custom logic. In accordance with an embodiment of the present invention, the rule definition module 202 includes an interest rule definition module 204 configured to define one or more interest rules to obtain the deterministic value of the interest, a currency rule definition module 206 configured to define one or more currency rules to obtain the deterministic value of the currency of payment and a principal rule definition module 208 configured to define one or more principal rules to obtain the deterministic value of the mode of payment.

The rule attachment module 210 is configured to attach the one or more rules to the one or more financial products. The one or more financial products can be categorized into one or more product types. The one or more product types include but are not limited to currency linked product, equity linked product, interest linked product and index linked product. The one or more rules are defined based on the one or more product types, one or more rule types, one or more product parameters and one or more spot parameters of the one or more financial products. The one or more rule types include an interest rule, a principal rule and a currency rule. The examples of the one or more product parameters include but are not limited to Interest Rate, Payment Mode, Cash, Equity, Product currency (product CCY), Underlying currency (underlying CCY), Payment currency (payment CCY), Lower Interest Strike, Upper Interest Strike, Lower Index Strike, Upper Index Strike, Lower FX Strike, Upper FX Strike, Lower Equity Strike and Upper Equity Strike. The one or more spot parameters include but are not limited to Spot price, Spot FX Rate, Spot Interest Rate and Spot Index Value. The one or more currency rules are applied to currency linked products and the one or more principal rules are applied to equity linked products.

The one or more rules for the one or more financial products are written as a condition. If the condition is true then a value is assigned. The step of defining the one or more rules includes at least one success step and at least one failure step. The operators can be used to define the one or more rules are =, >, <, >=, <=, +, * , /. The rule execution module 212 is configured to execute the one or more rules to obtain the deterministic value of the interest, the mode of payment and the currency of payment for the one or more financial products. The one or more rules are executed at the time of cash flow event calculation.

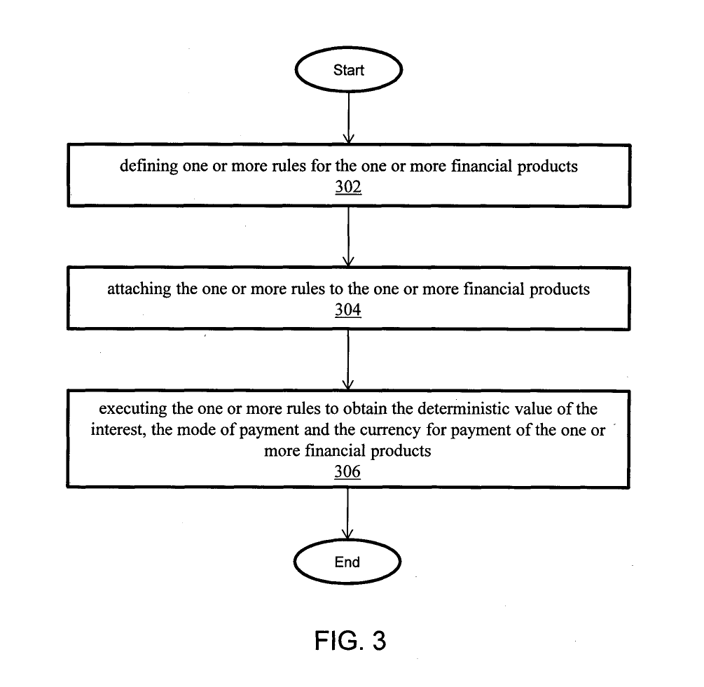

FIG. 3 is a flowchart, illustrating a method for obtaining a deterministic value of an interest, a mode of payment and a currency of payment for one or more financial products, in accordance with an embodiment of the present invention. The method includes defining one or more rules for the one or more financial products, at step 302. The step of defining one or more rules includes selecting a function code for the one or more rules. The function code includes Add, Copy, Delete, Inquire, Modify, Verify and Cancel. The one or more rules are identified by one or more Rule IDs. For a Rule ID, either one or more rules can be defined or one or more scripts can be attached. The one or more scripts provide flexibility to users to have custom logic.

The one or more rules are defined under an interest rule or a principal rule or a currency rule. The one or more rules are defined based on the rule types (interest rule, principal rule, currency rule), one or more product types, one or more product parameters and one or more spot parameters. The one or more product parameters include Interest Rate, Payment Mode, Cash, Equity, Product currency (product CCY), Underlying currency (underlying CCY), Payment currency (payment CCY), Lower Interest Strike, Upper Interest Strike, Lower Index Strike, Upper Index Strike, Lower FX Strike, Upper FX Strike, Lower Equity Strike and Upper Equity Strike. The one or more spot parameters include but are not limited to Spot price, Spot FX Rate, Spot Interest Rate and Spot Index Value.

Referring back to FIG. 3, the one or more rules are attached to the one or more financial products, at step 304. The types of the one or more financial products include currency linked products, equity linked products, interest linked products and index linked products. The one or more product parameters are mapped with the one or more financial product definition field. The mapping may be as follows:

| Sl. | Rule def. front end | |
|---|---|---|
| No. | field | Product definition field |
| 1 | Equity | Underlying Equity Code |
| 2 | Product CCY | Product CCY |
| 3 | Underlying CCY | Underlying CCY Code |
| 4 | Lower Interest Strike | Lower Strike Value for underlying Interest |
| | | rate code |
| 5 | Upper Interest Strike | Upper Strike Value for underlying Interest |
| | | rate code |
| 6 | Lower equity Strike | Lower Strike Value for Underlying Equity |
| | | Code |
| 7 | Upper equity Strike | Upper Strike Value for Underlying Equity |
| | | Code |
| 8 | Lower FX Strike | Lower Strike Value for Underlying CCY |
| 9 | Upper FX Strike | Upper Strike Value for Underlying CCY |
| 10 | Lower Index Value | Lower Strike Value for underlying Index |
| 11 | Upper Index Value | Upper Strike Value for underlying Index |

The one or more rules for the one or more financial products are written as a condition. A value can be assigned if the condition is true or false. The step of defining the one or more rules includes at least one success step and at least one failure step. The one or more rules are executed to obtain the deterministic value of the interest, the mode of payment and the currency of payment for the financial product, at step 306. The execution of the one or more rules is performed at the time of cash flow event calculation. An exemplary expression of defining the one or more interest rules and their execution may be as follows:

If (Lower index strike < Spot price index Value < Upper index Strike)
Interest Rate = 10%
Else
Interest Rate = 5%

The above rule is defined in the system using the steps:

| Step No. | Expression | Success Step | Failure Step |
|---|---|---|---|
| 1 | Lower index strike < | 2 | 4 |
| | Spot price index | | |
| | Strike | | |
| 2 | Spot price index | 3 | 4 |
| | Value < Upper index | | |
| | Strike | | |
| 3 | Interest Rate = 10 | 0 | 0 |
| 4 | Interest Rate = 5 | 0 | 0 |

In this case the success step is to pay interest at 10% and failure step is to pay interest at 5%. Success step's expression is executed next if the current step's expression returns success. Failure step's expression is executed next if the current step's expression returns Failure. If the lower index strike defined at the financial product is 4500 and the upper index strike defined at the financial product is 5000 and at the time of cash flow event calculation if the spot price index value is 4800, then a customer would get 10% enhanced interest on his investment.

An exemplary expression of defining the one or more principal rules and their execution may be as follows:

If Spot price value >= Lower Equity Strike
Payment Mode = Cash
Else
Payment Mode = Equity

The above rule is defined in the system using the steps:

| Step No. | Expression | Success Step | Failure Step |
|---|---|---|---|
| 1 | Spot price value > = | 2 | 3 |
| | Lower Equity Strike | | |
| 2 | Payment Mode = | 0 | 0 |
| | Cash | | |
| 3 | Payment Mode = | 0 | 0 |
| | Equity | | |

In this case the success step is to pay cash and failure step is to pay equity. If the lower equity strike defined at the financial product is 2200 and the time of cash flow event calculation the spot price value is 2100, then the customer would get the payment in equity (shares).

Similarly, an exemplary expression of defining the one or more currency rules and their execution may be as follows:

If Spot price FX Rate <= Lower FX Strike
Payment CCY = Product CCY
Else
Payment CCY = Underlying CCY

The above rule will be defined in the system using the steps:

| Step No. | Expression | Success Step | Failure Step |
|---|---|---|---|
| 1 | Spot price FX Rate <= | 2 | 3 |
| | Lower FX Strike | | |
| 2 | Payment CCY = | 0 | 0 |
| | Product CCY | | |
| 3 | Payment CCY = | 0 | 0 |
| | Underlying CCY | | |

In this case the success step is the product CCY and failure step is the underlying CCY. If product FX strike defined at the financial product is 50 and if product CCY is INR and underlying CCY is USD, and if at the time of the cash flow event calculation, the Spot FX Strike is 52, then the customer would get payment in USD currency.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim:

1. A computer implemented method executed by one or more computing devices for obtaining a deterministic value of an interest, a mode of payment and a currency of payment for one or more financial products comprises:
defining one or more rules for the one or more financial products;
attaching the one or more rules to the one or more financial products; and
executing the one or more rules to obtain the deterministic value of the interest, the mode of payment and the currency of payment for the one or more financial products.

2. The method as claimed in claim 1, wherein the step of defining one or more rules is based on one or more product types, one or more rule types, one or more product parameters and one or more spot parameters of the one or more financial products.

3. The method as claimed in claim 2, wherein the rule type comprises an interest rule, a principal rule and a currency rule.

4. The method as claimed in claim 1, wherein the step of defining one or more rules includes at least one success step and at least one failure step.

5. The method as claimed in claim 1, wherein the one or more rules are associated with one or more Rule IDs.

6. The method as claimed in claim 1, wherein the step of executing the one or more rules is performed at the time of cash flow event calculation.

7. A system for obtaining a deterministic value of an interest, a mode of payment and a currency of payment for one or more financial products comprising:
a processor in operable communication with a processor readable storage medium, the processor readable storage medium containing one or more programming instructions whereby the processor is configured to implement:
a rule definition module configured to define one or more rules for the one or more financial products;
a rule attachment module configured to attach the one or more rules to the one or more financial products; and
a rule execution module configured to execute the one or more rules to obtain the deterministic value of the interest, the mode of payment and the currency of payment for the one or more financial products.

8. The system as claimed in claim 7, wherein the rule definition module comprises:
an interest rule definition module configured to define one or more interest rules to obtain the deterministic value of the interest;
a currency rule definition module configured to define one or more currency rules to obtain the deterministic value of the currency of payment; and
a principal rule definition module configured to define one or more principal rules to obtain the deterministic value of the mode of payment.

9. The system as claimed in claim 8, wherein the one or more currency rules are applied to one or more currency linked products.

10. The system as claimed in claim 8, wherein the one or more principal rules are applied to one or more equity linked products.

11. The system as claimed in claim 7, wherein the rule definition module includes one or more scripts that are stored in a database.

12. The system as claimed in claim 11, wherein the one or more scripts are used to define custom logic.

13. The system as claimed in claim 7, wherein the one or more rules are defined based on one or more product types, one or more rule types, one or more product parameters and one or more spot parameters of the one or more financial products.

14. A computer program product for use with a computer, the computer program product comprising a computer readable medium having computer readable program code embodied therein for obtaining a deterministic value of an interest, a mode of payment and a currency of payment for one or more financial products, the computer readable program code storing a set of instructions configured for:
defining one or more rules for the one or more financial products;
attaching the one or more rules to the one or more financial products; and
executing the one or more rules to obtain the deterministic value of the interest, the mode of payment and the currency of payment for the one or more financial products.

15. The computer program product as claimed in claim 14, wherein the one or more rules comprise an interest rule, a principal rule and a currency rule.

16. The computer program product as claimed in claim 14, wherein the defining one or more rules includes at least one success step and at least one failure step.

17. The computer program product as claimed in claim 14, wherein the one or more rules are executed at the time of cash flow event calculation.
